(19) United States
(12) Patent Application Publication
(10) Pub. No.: US 2008/0315004 A1
(43) Pub. Date: Dec. 25, 2008

(54) Method of Delivering a Dispersion

(76) Inventors: Manfred Nagel, Maintal (DE); Josef Piroth, Mespelbrunn (DE); Dirk Schaffner, Bellheim (DE); Norbert Krebs, Langenselbold (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/091,252

(22) PCT Filed: Oct. 12, 2006
(86) PCT No.: PCT/EP2006/067350

§ 371 Date: Apr. 23, 2008

(30) Foreign Application Priority Data
Nov. 2, 2005 (EP) 05023814.6

(51) Int. Cl. B05D 1/02; B05B 9/00

(52) U.S. Cl. 239/1; 137/1

(57) ABSTRACT

A dispersion of a hydrophobic silicic acid in water is delivered by means of the dispersion being conveyed onwards by means of a squeezing motion.

The invention relates to a method of delivering a dispersion of a hydrophobic silicic acid in water.

The prior application of 3 May 2004 bearing the application file reference PCT/EP 2005/004069 (040133 FH) discloses a dispersion having insecticidal activity.

This dispersion, in addition to water, contains from 0.5 to 20 wt % of hydrophobic silicic acid, from 0.01 to 10 wt % of a gelling or viscosity-enhancing additive, from 0.1 to 1 wt % of a preservative, from 0 to 1 wt % of a surface-activating substance.

The known dispersion has insecticidal activity and can therefore be employed, for example, against mites, beetles, moths, lice, etc.

Application of a dispersion as an insecticidal agent requires this dispersion to be distributed in a suitable manner.

It is therefore an object of the present invention to find a method of disseminating and delivering a dispersion, by means of which the dispersion having insecticidal activity can be disseminated in such a manner as to achieve maximum activity.

The technical system for disseminating and delivering the dispersion should further be independent in terms of energy supplied (e.g. electricity, compressed air etc.), i.e. be self-sufficient.

The maximum geometric dimensions of the abovementioned technical system are limited by the operational environment.

Independently of the number of nozzles used (e.g. 1, 2, . . . 10 nozzles, a uniform spray pattern is to be ensured while the volume flow for each nozzle used is constant.

The present invention relates to a method of delivering and disseminating an aqueous dispersion of a hydrophobic silicic acid, characterized in that the dispersion is passed within a conduit and within the conduit is conveyed onwards by means of a squeezing motion.

According to the invention, the squeezing motion can be carried out by means of an apparatus selected from the group consisting of hose pumps, hose-type screw pumps, peristaltic pumps and rotary positive-displacement pumps.

The peristaltic pump or rotary positive-displacement pump is known from DE 197 13 689 and DE 197 17 452.

The method according to the invention allows the following predefined requirements to be met:

Application of the dispersion onto areas and rods, a uniform spray pattern being generated by means of the nozzles used.

The disseminated dispersion retains its insecticidal activity and has sufficient adhesion to the application areas.

The above-described requirements imposed on the invention are described by the invention.

### EXAMPLES

For the purpose of disseminating the dispersion, various pumps are available which operate according to the peristaltic principle or positive-displacement principle.

A main selection criterion is a particularly gentle delivery technology to prevent the dispersion from losing its insecticidal activity.

Hose pumps disclosed by
Bartholome E, Ullmanns Enzyklopädie der technischen Chemie, Verlag Chemie, 1973
Vauck, W., Müller, H., Grundoperationen chemischer Verfahrenstechnik [Chemical process engineering unit operations], Deutscher Verlag für Grundstoffindustrie, 2000.

Hose pumps have a resilient hose within a manifold casing which is open on the inside. Rotary rollers compress the hose and thus divide it into a suction and a discharge chamber. The maximum operating pressure of hose pumps is 10 bar.

As the flow medium is in contact solely with the delivery hose, there is no risk of corrosion. Moreover, hose pumps require very little maintenance.

The same documents further disclose Hose-type screw pumps.

In contrast to conventional hose pumps, a hose-type screw pump has a plurality of hoses. These are situated axially parallel to the central eccentric screw rotor and are compressed simultaneously. The maximum operating pressure is 6 bar.

As the flow medium is in contact solely with the delivery hose, these pumps likewise carry no risk of corrosion. Furthermore, the hose pump requires very little maintenance. Compared with the simple hose pump, the pulsation in hose-type screw pumps is significantly dampened.

Peristaltic pump Inomat M8 from INOTEC GmbH disclosed by
Inotec GmbH, operating instructions Inomat M8, Inotec GmbH, 2005
Kammerer, R., published application DE 197 17 452 A1, German Federal Printing Office, 1988
Kammerer, R., published application DE 197 13 689 A1, German Federal Printing Office, 1999

Similarly to the hose pump principle, the peristaltic pump from Inotec delivers the flow medium by means of a squeezing motion. However, the flow medium is contained not within a hose but between a flexible and a fixed plate. The flexible plate is deflected via individual, mobile pressure transmission elements which in turn are moved by a rotor running concentrically around the axis. As a result, the pump channel is divided into a suction and a discharge chamber. The maximum operating pressure is 15 bar.

Pulsation in the pump is low. Insecticidal activities are in accordance with requirements. As the pump is simple in design, it can be maintained and cleaned very easily and rapidly. The flow medium is in contact solely with the two plastic plates which are resistant to the dispersion.

Further known delivery principles do not meet the requirements as formulated at the outset. By way of example, a few pump types are mentioned below.

Piston pumps (disclosed by Vauck, W., Müller, H., Grundoperationen chemischer Verfahrenstechnik [Chemical process engineering unit operations], Deutscher Verlag für Grundstoffindustrie, 2000)

In the piston pump, the flow medium is delivered by means of a piston. The stroke motion of the piston as an oscillating displacer in a cylinder, given special designs, first draws the medium in a low-pulsation manner into the cylinder and subsequently forces it therefrom. In the process, discharge and intake valves alternately seal off the pumping chamber. The volume flow is adjusted via the dimension of the nozzles used and the operating pressure set. The maximum operating pressure for atomization is up to 230 bar.

Disadvantageously, the mite mortality levels do not meet requirements, as the mechanical stresses break down the dispersion. Undesirable wear of the components which come into contact with the dispersion, e.g. piston, cylinder and especially discharge and intake valves cause the pumps in question to fail when the product is used.

Electrically driven twin-diaphragm plunger pumps (disclosed by Vauck, W., Müller, H., Grundoperationen chemischer Verfahrenstechnik [Chemical process engineering unit operations], Deutscher Verlag für Grundstoffindustrie, 2000)

In contrast to piston pumps, a diaphragm forms the displacer in diaphragm pumps. The diaphragm is set into motion by being directly linked to the drive rod assembly. In so doing, the diaphragm completely separates the working chamber from the drive.

Within the pumping chamber separated off by the diaphragm there is no corrosion/abrasion.

Disadvantageously, the insecticidal activity achieved on mites is not in accordance with requirements. There is undesirable wear of the components which come into contact with dispersion, e.g. discharge and intake valves. Owing to the continuous bypass flow within the pump, the dispersion is subject to considerable stress, resulting in a reduction of its insecticidal activity. The complicated design of the pump makes maintenance/cleaning of the pump more difficult.

1. (canceled)

2. (canceled)

3. Method of delivering and disseminating an aqueous dispersion of a hydrophobic silica, comprising passing a dispersion of a hydrophobic silica within a conduit and conveying the dispersion within the conduit onwards by a squeezing motion.

4. The method of claim 3, wherein the squeezing motion is carried out by an apparatus selected from the group consisting of a hose pump, a hose-type screw pump, a peristaltic pump and a rotary positive-displacement pump.
